(19) United States
(12) Patent Application Publication
(10) Pub. No.: US 2007/0276775 A1
(43) Pub. Date: Nov. 29, 2007

(54) TEMPORAL VISUALIZATION ALGORITHM FOR RECOGNIZING AND OPTIMIZING ORGANIZATIONAL STRUCTURE

(75) Inventor: Peter A. Gloor, Cambridge, MA (US)

Correspondence Address: BARLOW, JOSEPHS & HOLMES, LTD., 101 DYER STREET, 5TH FLOOR, PROVIDENCE, RI, 02903, US

(73) Assignee: IQUEST GLOBAL CONSULTING, LLC, Rehoboth, MA (US)

(21) Appl. No.: 11/834,710

(22) Filed: Aug. 7, 2007

Related U.S. Application Data
(62) Division of application No. 11/238,252, filed on Sep. 29, 2005.
(60) Provisional application No. 60/615,536, filed on Oct. 1, 2004.

(51) Int. Cl. G06F 15/18

(52) U.S. Cl. 706/13

(57) ABSTRACT

A system is provided that takes as input the interrelationships which are observed between identified resources, and automatically generates interactive movies that depict a visualization of the of the interaction patterns among the identified resources. Each resource is represented as a dot. A line between two dots indicates a relationship. The closer the two dots are placed together, the more intensive is their relationship, that is, the more commonality or interaction those resources share. Further, the most active resources, namely the resources that have the most relational links or lines extending therefrom, are placed in the center of the network. Once the visualization movie has been built, a user can search for groupings of related resources by simply searching for and identifying the various clusters within the network.

### CROSS-REFERENCE TO RELATED APPLICATIONS

This application is a divisional of U.S. patent application Ser. No. 11/238,252, filed Sep. 29, 2005 which is related to and claims priority from earlier filed U.S. Provisional Patent Application No. 60/615,536, filed Oct. 1, 2004, the contents of which are incorporated herein by reference.

### BACKGROUND OF THE INVENTION

The present invention relates generally to efficient analysis and visual presentation of related resources. More specifically, the present invention relates to a method and system for analyzing and presenting groupings of related resources in a manner that assists the user in identifying the various correlations and interactions that exist between the discrete resources within the grouping.

As technology has progressed and use of the Internet has become more wide spread, the ability for people to collaborate across long distances and share vast volumes of information has dramatically increased. In fact, largely as a result of the Internet and the convergence of communication technologies, data collections and technological innovations no longer require long periods of time to disseminate. Through the use of modern technology, large groups of people are able to collaborate at the speed of light. Many of the technologies that are the backbones of our virtual world, such as the Internet, the World Wide Web, and Linux have been created as work products of such collaborative efforts. In this context, vast networks of interrelated resources, data and people exist that stretch out over great distances.

The now famous experiment of sociologist Stanley Milgram, clearly illustrated that in the modern world, underlying networks and resource groupings existed that serve to virtually eliminate barriers of time and distance displacement between people. Milgram asked fifty people in the Midwest to send a letter to a final recipient, whom they did not know in the Northeast of the US. The catch was that people in the Midwest were not allowed to directly mail the letter to the recipient. Instead, they had to forward the letter to another person whom they knew on a first name basis, and whom they thought might be closer in some way to the final recipient of the letter. Each intermediary recipient of the letter was supposed to repeat this experiment until the letter finally reached its destination. To the surprise of Milgram it took only an average of six steps for any one of the original fifty letters to reach its destination. The conclusion of Milgram was that indeed the US is a small world, with the population being surprisingly well connected by an underlying social network that may not be immediately visible to an outside observer.

Recognizing that the availability of resources including people and data were in fact spread out over a large and fairly well structured network prompted businesses to reevaluate their business processes in a manner that would allow then to take advantage of the resources available over this network. While businesses generally have been able to exploit the available technologies in a mechanical fashion to optimize their business processes, they have largely overlooked the need to also optimize the flow of largely unstructured, knowledge-intensive innovation processes and data collections in a manner that identifies the underlying relationships imbedded within the resource network.

The underlying concept that describes the operation of this large network has been described as “swarming”, a term that has been popularized by computer scientist Eric Bonabeau. The term swarming has been used to describe the concept of a network of collective intelligence and resources because of its amazing similarity to the behaviors observed in social insect colonies. While one insect within an insect colony may not be capable of much, collectively, social insects when working collaboratively are capable of achieving great things such as building and defending a nest, foraging for food, taking care of the brood, allocating labor, forming bridges, and much more. If a single ant is observed out of the context of the underlying network, the observer may have the impression that the ant is behaving randomly or out of synchrony with the rest of the colony. However, often an observer will also see impressive columns of ants that can run from tens to hundreds of meters in length. Such ant highways are highly coordinated forms of collective behavior that have formed in order for these social insects to successfully solve a complex task. It is the participation in the underlying network that provides the required context in which an observer is capable of actually understanding a single resource's role in the overall colony. It is well known that beehives and ant colonies resolve sophisticated problems such as identifying the most plentiful food source or building bridges by applying collective intelligence based on an underlying network structure. However, this conclusion was only reached after years of observation, which in turn served to develop a visualization framework that explained the behavior of each of the resources in the proper context.

Similarly, people, like social insects are utilizing swarm intelligence on a daily basis both through direct online collaboration and indirect collective knowledge development. The difficulty arises in attempting to harness and evaluate the products produced through swarm intelligence. This is mainly because the process and product of swarm intelligence can look quite chaotic and random from the perspective of the outside observer much in the same way as the behavior of the individual insect appears random when observed out of the context of the underlying social network. However, in reality, the process and ultimate end products are generally organized in an extremely efficient manner with a recognizable underlying pattern thanks to self-organizing collaboration of swarm members.

In order to harness the underlying potential associated with swarm intelligence, the ability to visualize various bases for relationships between unrelated resources becomes highly desirable. Without the ability to automatically identify such relationships, often the relationships go unnoticed or must be identified by analyzing large quantities of information through a manual process. This type of problem frequently arises in the context of swarm intelligence and collaborative resource pools such as is available on the Internet, where a need exists for a user to access information relevant to their desired search without requiring the user to expend an excessive amount of time and resources searching through all of the available information.

In order to overcome the cumbersome nature of the problem identified above, methods of targeted information analysis have been created that use various techniques. One such technique is keyword matching, where a user specifies a set of keywords that the user believes will help identify and distinguish the desired resources from the entire body of available intelligence. The computer then uses these keywords to retrieve all of the available resources that relate to those keywords chosen. While keyword searching produces fast results, searches based on such methods are typically unreliable, generally collecting a large number of resources that are not particularly relevant to the desired search. Further, the results are typically provided in a listed fashion that fails to assist a user in identifying the underlying relationships that exist between the various identified results.

To enhance keyword searching and improve its overall reliability and the quality of the identified resources, a number of alternate approaches have been developed for use in information retrieval. Some of these methods rely on interaction with the entire body of users, either actively or passively, wherein the system quantifies the level of interest exhibited by each user relative to the resources identified by their particular search. In this manner, statistical information is compiled that in time assists the overall network to determine the weighted relevance of each resource contained therein. Other alternative methods provide for the automatic generation and labeling of clusters of related resources for the purpose of assisting the user in identifying relevant groups of documents. However, none of these modified search techniques provide the ability to visualize the underlying interrelationships that may exist between the selected resources.

There is therefore a need for a method and system for analyzing large groups of related resources to determine the underlying network arrangement that connects each of the discrete resources to one another. There is a further need for method and system for analyzing large groups of related resources to identify the underlying network arrangement in a manner that enables the user to visualize the quality and relative strength of the relationships between the discrete resources. Finally, there is a need for a method and system that enables optimization of the underlying organizational network through visualization of the quality and relative strength of the relationships between the discrete resources contained within the network.

### BRIEF SUMMARY OF THE INVENTION

In this regard, the present invention provides a method and system for visualizing interaction patterns between related resource items. As such, the general purpose of the present invention, which will be described subsequently in greater detail, is to provide a method and system for the visual identification and analysis of the dynamics of the interrelationships between identified resources. The system in effect provides both an interactive movie and a static 3-dimensional surface view depicting the interaction between identified resources based on their relative interactions and/or interrelated features thereby identifying and visualizing the underlying organizational network. By comparing dynamic interaction patterns, typical organizational or relational patterns are identified thereby allowing a visual analysis of the resources in a manner that allows improvements in resource arrangement and higher efficiencies in resource groupings.

Accordingly, the system of the present invention takes as input the interrelationships that are observed as existing between identified resources, and automatically generates interactive movies that depict a visualization of the of the interaction patterns among the identified resources. Each resource is represented as a dot. A line between two dots indicates a relationship. The closer the two dots are placed together, the more intensive is their relationship, that is, the more commonality or interaction those resources share. Further, the most active resources, namely the resources that have the most relational links or lines extending therefrom, are placed in the center of the network. Once the visualization movie has been built, a user can search for groupings of related resources by simply searching for and identifying the various clusters within the network. In this manner, the system of the present invention provides a tool for easy visual identification of related groups of resources.

Accordingly, it is an object of the present invention to provide a method and system whereby underlying interrelationships between related resources can be identified visually. It is a further object of the present invention to provide a visualization system for identifying interrelationships between various resources in a manner that assists in identifying the relative strengths of each of the interrelationships thereby providing useful information for identifying related resource groups. It is still a further object of the present invention to provide a visualization method for displaying interrelationships between resources that allows efficient grouping of the resources.

These together with other objects of the invention, along with various features of novelty, which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is an illustration depicting a snapshot display produced by the visualization system of the present invention;

FIG. 2 is an illustration of two distinct snapshots in time depicting the identification of correlated clusters using the system of the present invention;

FIG. 3 is a schematic illustration depicting the operation of the sliding time frame algorithm of the present invention;

FIG. 3A depicts the operation of the siding time frame algorithm on a temporal graph; and

FIG. 3B depicts the operation of the sliding time frame algorithm on a temporal graph with the history maintained.

FIG. 4 shows dynamics of a group of resources on a temporal social surface

### DETAILED DESCRIPTION OF THE INVENTION

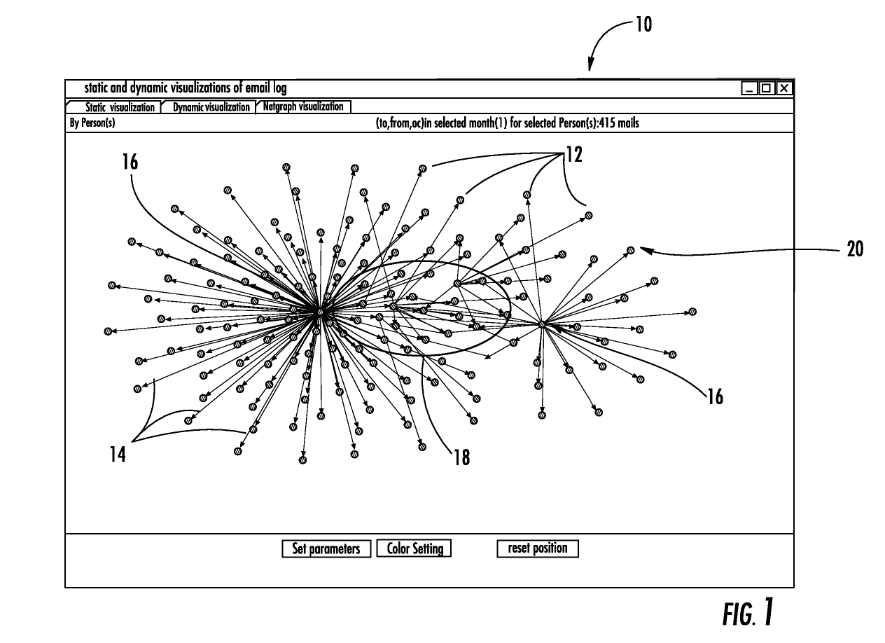

Now referring to the drawing figures, a representative display 10 of the output from the visualization system of the present invention is shown in FIG. 1 and represents a single snapshot in time. As can be seen, each of the discrete resources 12 is generally depicted as a dot, while a line represents each of the interrelationships 14 between discrete resources 12. The relative placement of the dots representing resources 12 coincides to the relative activity of that resource 12, while the relative length of the line representing the interrelationships 14 coincides to the relative strength of the interrelationship 14 of the connected resources 12. The specifics related to these concepts will be discussed in greater detail below.

It can be appreciated that in the context of the present invention it is important to note that the term resources 12 is meant to represent a broad range of organizational concepts. While in any given analysis, all of the resources 12 presented will be alike, generally, the resources 12 are meant to represent any necessary resource 12 for conducting business. The following list is meant to illustrate a few examples of what the term resources 12 may encompass, but in no way is meant to be all inclusive or limiting on the scope of the present invention. By way of illustration, resources 12 may include people, equipment, documents, discrete elements of data, email communications, etc. Similarly, interrelationships 14 between each of the resources 12 may simply mean, in the context of people, personal relationships, similarities in interests or communications between people, while in the context of hard resources 12, interrelationships 14 may mean commonality of purpose, similarities of data contained therein or interrelated conceptual matter. Generally, as will be discussed below, the purpose of the present invention is simply to provide a visualization system that is broadly applicable over a wide conceptual spectrum, wherein the relative frequency and strength of interrelationships between discrete resources 12 can be displayed graphically in a manner that visually identifies resource 12 clustering or interrelatedness.

Turning back to FIG. 1, the resource 12 dots that are located closer to the center of any given cluster 16 are positioned centrally because they are the most active or most highly relevant resources 12 to that cluster 16. Accordingly, the most relevant or interrelated resources 12 to any given group will typically be concentrated near the center of any given cluster 16. In addition, the length of any interrelationship 14 line connecting two resources 12 relates to the strength of the interrelationship 14 between those resources 12. A longer interrelationship 14 line illustrates a lower level of interrelationship 14 while a shorter interrelationship 14 line represents a higher level of interrelationship 14. Therefore, in viewing this snapshot as depicted in FIG. 1, it can be seen that those resource 12 dots that are located in the central region of a given cluster 16 and most tightly grouped are those resources 12 that are most closely interrelated and active for any given inquiry. Conversely, those resource 12 dots that are less active and separated by longer interrelationship 14 lines represent resources 12 that are less pertinent or relevant to the given inquiry. It should also be noted that two distinct clusters 16 can be seen in the visualization presented in FIG. 1. Clearly in this case, a large group of resources 12 tend to interact with one another in the cluster 16 on the left while there is another cluster 16 that has emerged on the right that is not as definitive but includes its own level of internal interrelatedness.

What is most interesting in this visualization display 10 however is that there is a clustered group of resource 12 dots located in the ellipse 18 that is both closely related (clustered) and share a very high level of interaction between each and every resource 12 that resides within the ellipse 18. This can be clearly contrasted to the central resource 12 dots in the two clusters 16 on the left and right, wherein the interrelatedness 14 appears simply as a star pattern. It is the combination of both the clustering 16 and the high interrelatedness 14 that extends from each of the distinct resources 12 within a cluster 16 to each of the other resources 12 within the cluster 16 that indicates that this group of resources 12 is highly correlated (i.e. highly clustered and highly interrelated).

In general the system of the present invention is tailored to analyze the interrelationships 14 that exist between identified groups of resources 12 to determine whether patterns exist that indicate correlation of resources 12 and then evaluate the relative strength that the patterns exhibit to determine if the clusters 16 are simply normal and predicted correlations or highly related resource 12 correlations. As was stated above with regard to FIG. 1, clearly two clusters 16 of loosely related resources 12 are demonstrated. However, these clusters 16 take on a star pattern where a single central resource 12 appears to tie the remaining related resources 12 together. It can be clearly seen that the resources 12 that lie out on the arms of the stat pattern in the cluster 16 have little connection to one another. In the context of an office, the central resource 12 in this case may be a department manager for example. By observing such a cluster 16 patter, the visualization system of the present invention provides a person making a query with a visual representation of the relative strength and interrelatedness 14 between these various resources 12 on an organizational level. Ultimately all of the selected resources 12 are analyzed to identify the interactions therebetween. The resources 12 and their interrelationships 14 are all then arranged to depict the underlying organizational network that exists.

As stated above however, while typical cluster 16 such as are shown at the left and right of FIG. 1 are expected and tend to correlate to the known organizational structure of the resources 12, the visualization system of the present invention is particularly useful in identifying the highly correlated clusters such as appears in the ellipse 18, which are not normally predicted. In addition to the left and right star shaped clusters 16 shown in FIG. 1, a more amorphous circular cluster can be found in the ellipse 18. This cluster has identified resources 12 that are both highly related as can be seen from their proximity and also highly correlated as can be seen from the high level of interactivity between each of the resources 12 with each of the other resources 12 within the cluster.
In this regard to successfully identify these highly related and highly correlated resource 12 clusters 18, it is also important to note that the level of interrelatedness between any given grouping of resources 12 varies as a function of time. To formally describe the evolution of the visual patterns over time such as is depicted in the resource interrelation graph 20 shown on the display 10, a variable describing the connectivity structure of the underlying network, called group betweeness centrality (GBC) is calculated. GBC is a popular measure in social network analysis. It is based on resource betweenness centrality, which has been defined as the probability that information in a given network of resources flows through any given resource within the network. (Freeman, L. C., “A Set of Measures of Centrality Based on Betweenness”, Sociometry, Vol. 40, pp. 35-41 (1977)). The GBC value represented as C_{B} in the formula presented below is now defined as:

$${C}_{B} = \frac{2 {\sum }_{g - 1}^{B} [ {C}_{B} ( {n}^{*} ) - {C}_{B} ( {n}_{i} ) ]}{[ {( g - 1 )}^{2} ( g - 2 ) ]}$$

Where gⱼₖ(nᵢ) is the number of geodesics (shortest paths) linking any given resources and also involving the resource in question. C_{B}(n*) is the largest resource betweenness centrality, and g is the total number of resources. In simplest terms the resource betweenness centrality for resource nᵢ is the sum of these estimated probabilities over all pairs of resources excluding the ith resource. Further documentation of the manner in which GBC values are calculated and the theory behind GBC will not be presented herein because this principal in general is well known and documented in the prior art.

When talking in absolute terms, the GBC of an entire cluster 16 of resources 12 is 1 for a perfect star structure, where one central resource 12, the star, is the controlling resource 12 in a cluster 16 much as is depicted in the right and left clusters 16 of FIG. 1. Similarly, the GBC is 0 in a totally democratic structure where all of the resources 12 display an identical interrelatedness 14 pattern, similar to the cluster in the ellipse 18 in FIG. 1. Therefore when viewing a GBC value in operation, the lower the GBC value and the higher the resource interrelatedness graph 20 density at any particular time, the more interrelated 14 each of the resources 14 in the selected cluster 18 are. To discover typical interrelatedness patterns and identify the resource 12 clusters 18 of interest, the algorithm of the present invention utilizes a three-step-process:

1. Monitor interrelation visualization graphs 20 over time to identify dense clusters 18.

2. Look for peaks and troughs in the GBC value overtime and compare abrupt changes to dense clusters 18 identified in the interrelation visualization graphs 20 to find the points of highest interrelatedness 14.

3. Look at the relative interrelatedness 14 of the resources 12 in a high density and highly interrelated cluster 18 to determine the relative relevance or importance of each of the resources 12 within the cluster 18 as compared to one another.

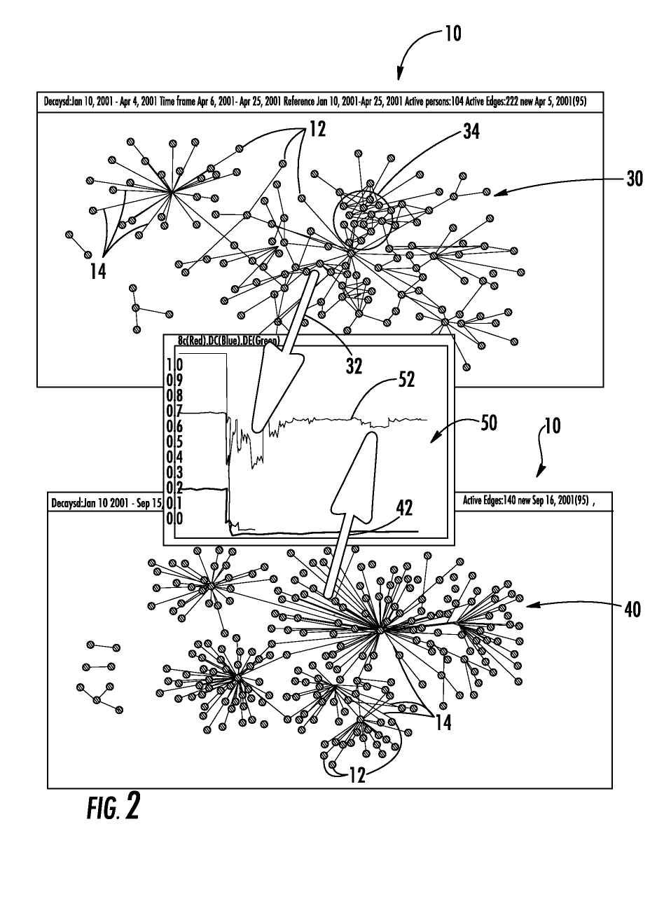

Turning now to FIG. 2, two visual displays 10 are shown with snapshots of the interrelatedness graphs 30, 40 taken at different points in time are illustrated as they relate to a temporal graph 50 depicting GBC value 52 over time. In performing the first step of the analysis of the present invention, the interrelatedness graphs 30, 40 are compared over time as can be seen in the side-by-side comparison of the two snapshots 30, 40. Using the comparison of the snapshots 30, 40 allows particularly dense clusters of resources to be identified. In the second step, a review of the temporal graph 50 representing GBC 52 allows points where the GBC 52 rapidly drops to be identified which in turn typically indicates levels of high correlation between resources within the graph. In particular, the snapshot 30 depicted in the upper display 10 correlates to the point on the temporal GBC graph 50 indicated by the arrow 32. Further, the snapshot 40 depicted in the lower display 10 correlates to the point on the temporal GBC graph 50 indicated by the arrow 42. As can be seen in FIG. 2 as the GBC value 52 drops the top snapshot 30 clearly shows a highly clustered and highly correlated group of resources 12 in the circled region 34. Similarly, as the GBC value 52 returns to a higher level, the high correlation disappears. Using this temporal information, analysis can be focused on the interrelatedness graphs 30, 40 that correspond to the time period during the drop in the GBC value 52 and following the GBC value 52 return to a normal or baseline level. In comparing those two interrelatedness graphs 30, 40 a strong correlation of interrelated resources 12 can be identified as is shown within the circular region 34 in FIG. 2.

As was discussed above, to identify regions of increased correlation and interrelatedness between resources, an observer must monitor the GBC value 52 over time. By looking at the evolution of the GBC value 52 on a temporal graph, the observer to get a quick overview of the temporal dynamics of a group of related resources 12. When an observer locates peaks and troughs in the temporal evolution of the GBC value 52 in conjunction with dense clusterings of resources 12 in the interrelatedness graphs 40,50, the observer essentially is able to identify the interrelatedness and correlation patterns of resource 12 groups. To further enhance the visualization of such interrelatedness information, the present invention utilizes the concept of temporal surfaces to assist an observer in visualizing changes in resource 12 dynamics. Temporal surfaces are uniquely suited to visualize and discover the relevant fluctuations over time in GBC value 52.

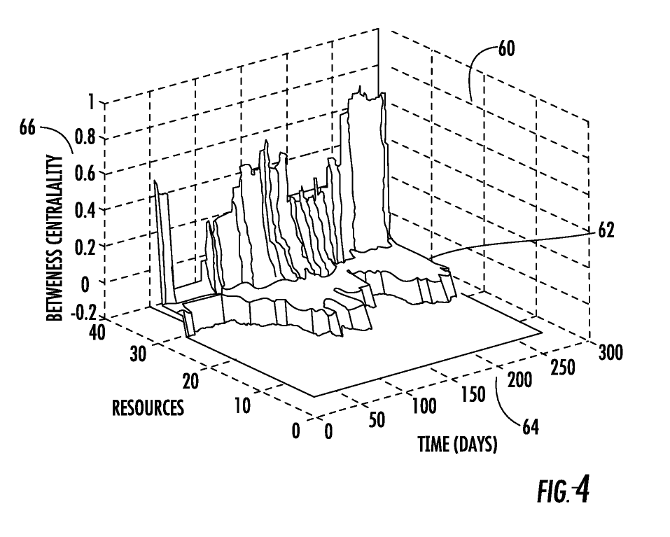

As was discussed in FIG. 2, a temporal graph 50 of the evolution of the GBC value 52 is shown. In this depiction, the GBC value 52 is depicted in a two dimensional fashion wherein the GBC value 52 plotted is a composite value for all resources collectively. Turning to FIG. 4, instead of plotting the GBC value 52 as a two dimensional composite representation, the visualization method of the present invention provides for producing a plot of the GBC value 52 that is represented as a GBC value surface 62 which is a three dimensional representation of the GBC value 52 for each of the resources 12 in the group of interest. In this case the visualization 60 is depicted on a graph where the x-axis is the temporal scale 64, the y-axis is the GBC value 66 and the z-axis is the number of resources in the group 68. As compared to the two dimensional plot 50 of the evolution of GBC value 52, it can be seen that by adding a curve for each individual resource 12 and accumulating those curves to form a surface 62, the observer is presented with a much richer visualization 60. To further enhance the surface 62 depiction, each of the curves related to an individual resource 12 is sorted by increasing value thereby smoothing the surface 62. The price to pay for this better readable surface 62 is the loss of traceability for individual resources 12. In interpreting the GBC value surface 62 in FIG. 4, it can be seen that the majority of resources 12 are inactive at any given time, but an observer can easily identify peaks in the GBC value 52 as the peaks appear as “elevated planes” and “peaks” in the surface 62.

Finally, in the third step of the process, once the cluster 34 of highly interrelated 14 resources 12 is identified based on step 2, the relative strength of interrelatedness 14 of each of the resources 12 in that cluster 34 is determined thereby, identifying the most highly relevant resource 12 in the cluster 34. Further, the remaining resources 12 in that cluster 34 can be arranged relatively based on the strength of their overall interrelatedness 14 to the remaining resources 12 in the cluster 34. This determination of relative strength is defined as a measure called the contribution index, which essentially gauges the overall level of interrelatedness for each given resource 12 within the cluster 34. The contribution index is defined as follows:

$$\frac{outgoing interrelatedness lines - incoming interrelatedness lines}{outgoing interrelatedness lines + incoming interrelatedness lines}$$

Based on this calculation, the contribution index is +1, if a resource 12 in a cluster 34 has only outgoing interrelatedness lines 14 and does not have any incoming interrelationship lines 14. Similarly, the contribution index is −1, if a resource 12 in a cluster 34 has only incoming interrelatedness lines 14 and does not have any outgoing interrelatedness lines 14. Finally, the contribution index is 0, if a resource 12 has totally balanced interrelatedness behavior with an equal number of outgoing and incoming interrelatedness lines 14. Using the contribution index in conjunction with the actual number of interrelatedness lines 14 incoming or outgoing from a given resource 12 allows its relative strength in any given cluster 34 to be determined.

In this manner, the visualization method of the present invention allows an observer to easily and quickly distinguish different and emerging correlations between related resources 12 in a highly visual manner. Further, by observing changes in the GBC value 52 as compared to snapshots in time from the resource interrelatedness graphs 30, 40, an observer can identify interrelatedness patterns almost immediately as the interrelatedness graphs 30, 40 are generated.

In practical application, the system of the present invention can be seen to be highly usefully in mining collections of resources 12 to identify relevant interrelationships 14 between the resources 12 in a highly graphical and visually identifiable manner. By applying the system of the present invention, the algorithm automatically identifies certain interrelatedness 14 clusters and the strength of correlation between the resources 12 and then visually weights relative strength of the resource 12 correlation within the cluster. In this manner, the system of the present invention provides a visual display 10 that identifies various correlations and interrelationships 14 between unrelated resources 12 that allows an observer to quickly identify clusters when analyzing large quantities of resource items 12. Without the ability to automatically identify such interrelationships 14, often only the predictable structural interrelationships are identified and other important underlying clusters of correlation are overlooked.

In the context of the visual display described above, in order to identify the interrelationships that develop over time and produce the visual display, the present invention utilizes a dynamic visualization algorithm wherein the layout of the interrelatedness graphs 30, 40 is recalculated over a predetermined, fixed time period. In the most simplistic manner, this recalculation period could be selected as a single day wherein the interrelatedness graph 30, 40 for any particular frame is generated once per day based on the available relationship data observed for that day. In this manner each frame is calculated automatically on a daily basis thereby generating a series of frames 10, each representing one day depicting a discrete interrelatedness graph 30, 40, wherein the series of frames 10 can then be viewed as an interactive movie. This simplistic approach, however, tends to generate an animation that lacks continuity and appears jerky.

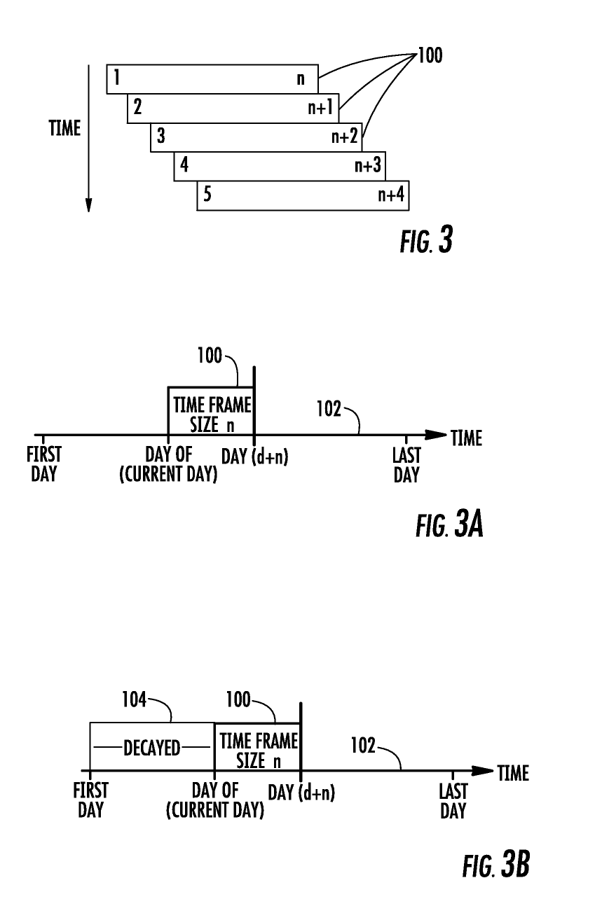

Instead of employing a simplistic stepped algorithm, the present invention utilizes a sliding time frame algorithm to calculate the interrelatedness graphs. Specifically, the algorithm of the present invention performs the interrelatedness calculation that underlies any given frame of the interrelatedness graph based on a predetermined interval of time. Turning to FIG. 3 a schematic illustration of the operation of the sliding time frame algorithm is depicted. In operation, the time interval 100 is selected and represented by the duration n. Essentially, the time interval 100 operates as a window that brackets the beginning and end of the time period between which the collected interrelatedness information will be displayed in any give calculated interrelatedness graph frame. The window or time interval bracket 100 is then advanced by one day and a time period starting on the second day and lasting for an interval n is utilized to calculate a new frame depicting the interrelatedness graph wherein the data from the day prior to the opening bracket is no longer included in the calculation but the data in the newly revealed day is included. FIG. 3A depicts the time frame interval 100 advancing overall temporal graph 102. Optionally, as is depicted in FIG. 3B, as the time frame interval 100 is advanced and the new frame is calculated, the interrelatedness data from prior frames may be maintained and carried forward to depict the moving history 104 of the interrelatedness graph. In such a case, preferably the history 104 information is depicted in a manner that allows it to be contrasted with the current data such as by dimming the history data 104. By utilizing the sliding time frame algorithm of the present invention and carrying forward the historic data 104, the changes in the related GBC values for any given period tends to be smoothed out generally because the overall interrelatedness graph has enough data on which to base unusual interrelatedness issues as compared to the typical interrelatedness information related to organization structure. In this manner, large changes in the GBC value, with historic data accounted for, tend only to result when new highly interrelated and highly correlated clusters appear.

An additional feature of the visualization system of the present invention is the use of keyframing. In producing the final visualization animation, only selected frames that occur at given equally spaced increments of new resource connections are compiled. This produces a visualization animation that allows a viewer to analyze large amounts of data in an shorter and more efficient animation. Each frame of the animation is first calculated using the sliding time frame algorithm discussed above. Then, a series of equally spaced frames are selected from the precalculated group of frames, these frames are identified ad the key frames. In the context of analyzing email traffic, key frames may be selected, for example based on the aggregate number of emails exchanged, i.e., one key frame for every 100 emails exchanged. The key frames are then compiled on into the finished visualization animation. Since the transition between each of the key frames may not be smooth, the present invention employs a technique called inbetweening to smooth the visual transition between each of the key frames in the finished animation. Ultimately, this means that while all the positions for all of the resources and all of the interrelatedness lines between the resources are preprocessed for the entire time period of the animation and cached in arrays in main memory, the finished animation only relies on periodic samplings of the calculated frames to generate the finished visualization animation.

To further enhance the efficiency of the visualization animation, the user may group related resources into a single virtual resource for the purpose of the interrelatedness calculation. In practice the related resources may be redundant pieces of information, several aliases used by a single person within an organization or multiple resources that are all provided form a related organization. In this manner the number of overall resources depicted as nodes within the visualization animation can be reduced in a manner that allows the resultant visualization to be more meaningful to the user.

The system of the present invention has many practical applications. For purpose of illustration, there is provided herein an example wherein the resources 12 of interest are people and the interrelatedness 14 connections represent communications such as emails exchanged between the people. As can be expected, the typical pattern wherein a communication star pattern develops simply indicated a loosely organized affiliation of people communicating in a normal and predictable manner. However, over time as dense clusters of people develop that have a more circular pattern with a GBC value that rapidly decreases an visual indication is produced that this particular cluster of people has both a high level of interrelatedness as well as a high level of correlation. In real terms such a visual indication may identify this group as coordinating their individual efforts toward a single purpose such as a terrorist attack.

For the purpose of illustration a second example may include resources 12 that represent the various informational documents available on the Internet and the interrelationships 14 represent common subject matter that is found in each of the documents. In this case as a star patterned cluster appears, an indication is provided that the group of documents are loosely related and contain discrete elements of common subject matter. In contrast, however, ad the GBC value rapidly decreases and the interrelatedness lines begin to extend in a more circular pattern wherein the lines extend between each of the resources within the cluster, a visual representation is created that indicates the particular documents within such a cluster each contain information that is both related and highly correlated to each of the other documents within that cluster thereby giving a higher probability that the documents within the cluster are relevant to the inquiry at that given time.

It can therefore be seen that the present invention provides a novel system and method of producing a visual analysis of the interrelatedness and correlation between an identified group resources. Further, the present invention provides a system that quickly identifies emerging trends in clustering of related data and presents those trends in a manner that allows an observer to quickly obtain clusters of resources that are highly interrelated and correlated. For these reasons, the instant invention is believed to represent a significant advancement in the art, which has substantial commercial merit.

While there is shown and described herein certain specific structure embodying the invention, it will be manifest to those skilled in the art that various modifications and rearrangements of the elements of the system may be made without departing from the spirit and scope of the underlying inventive concept and that the same is not limited to the particular forms herein shown and described except insofar as indicated by the scope of the appended claims.

What is claimed:

1. A system for visually identifying and displaying correlations between selected resources:
a visual display means;
a graphic representation of each of said selected resources arranged on said visual display means;
a graphic representation of the relative interrelatedness between each of said selected resources as a function of passing time; and
an algorithm that monitors changes in the relative interrelatedness between each of said selected resources as a function of passing time to determine discrete times wherein the relative interrelatedness between some of said selected resources is at a particularly high level.

2. The system of claim 1, wherein said graphic representation further comprises:
an array of dots, wherein each of said dots depicts each of said selected resources; and
an array of lines, each of said lines extending between two of said dots within said array of dots, wherein each of said lines represents an interrelationship between said two dots.

3. The system of claim 2, wherein said algorithm varies the positioning of said dots within said array based on the relative interrelatedness of each of said resources corresponding to said dots.

4. The system of claim 3, wherein the dots representing closely related resources are positioned in dense clusters relative to one another and the dots representing peripherally related resources are positioned at a greater distance relative to the more closely related resources.

5. The system of claim 4, said algorithm comprising the following steps:
monitor interrelatedness of said selected resources over time to identify dense clusters;
monitor the number and density of lines extending between each of said resources and periodically calculate a constant that represents the relative interrelatedness between all of the resources at that point in time;
identify points in time wherein said constant abruptly changes;
examine dense resource clusters during the points in time wherein the constant abruptly changes to locate resource clusters that are highly interrelated and highly correlated;
determine and rank the relative interrelatedness of each of the resources within said highly related resource clusters.

6. The system of claim 5, wherein said algorithm utilizes a plurality of points in time to generate a series of graphic representations, wherein said each graphic representation in said series of graphic representations is displayed sequentially to produce said temporal visualization.

7. The system of claim 6, wherein said series of graphic representations are incrementally sampled to generate key frames, wherein only said key frames are displayed sequentially to produce said temporal visualization.

8. The method of claim 7, wherein said algorithm performs a calculation to smooth the visual transition between each of said key frames before sequentially displaying said key frames.

9. The system of claim 1, wherein said step of monitoring changes in the relative interrelatedness between each of said selected resources over a period of time further comprises:
selecting an observation window having a duration that is less than said period of time;
collecting a first set of data related to interrelationships between each of said resources during said observation window;
storing said first set of data;
advancing said observation window incrementally within said period of time;
collecting a subsequent set of data related to interrelationships between each of said resources during said advanced observation window; and
storing said subsequent set of data.

10. The system of claim 9, wherein said data collection process is repeated until said observation window has been advanced to the end of said time period.

11. The system of claim 10, wherein each of said subsequent sets of data partially overlap at least one of an earlier collected set of data.

12. The system of claim 10, wherein each of said subsequent sets of data includes the information collected in each of said earlier collected sets of data.
